(19) United States
(12) Patent Application Publication
(10) Pub. No.: US 2010/0235076 A1
(43) Pub. Date: Sep. 16, 2010

(54) ESTIMATION OF FUEL CONSUMPTION FROM GPS TRAILS

(75) Inventors: Eyal Ofek, Redmond, WA (US); Yonatan Wexler, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/401,484

(22) Filed: Mar. 10, 2009

(51) Int. Cl. G06F 19/00

(52) U.S. Cl. 701/123

(57) ABSTRACT

A method of using locational information for vehicles to determine the cost of traveling on transportation segments is disclosed. The transportation segment costs calculated may be used for many purposes such as providing the lowest cost travel path between two locations at a given time or in general. The cost also may be used to assign tolls and congestion pricing. In addition, the data may be used to determine when a certain vehicle has become less efficient and may require maintenance.

### BACKGROUND

This Background is intended to provide the basic context of this patent application and it is not intended to describe a specific problem to be solved.

As road and other means of transportation become more and more crowded, there exists more and more interest in efficient travel. In addition, as supplies of natural resources diminish, the need for efficient travel continues to increase. Travel information is usually available over radio and in some navigation systems. However, translating travel times or travel speeds into actual costs would provide even more meaningful information.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method of using locational information for vehicles to determine the cost of traveling on transportation segments is disclosed. Vehicles are assumed to have a full tank of gas and the travel of the vehicles between transportation segments is tracked and stored until the vehicle stops for fuel again. The transportation segments traveled are then normalized and entered into a linear programming model, and, once enough data is accumulated, the cost of each transportation segment traveled is computed. The costs calculated may be used for many purposes such as providing the lowest cost travel path between two locations at a given time or in general. The cost also may be used to assign tolls and congestion pricing. The cost may be used to determine possible problems in the road network (congestion, low quality road, etc.) in order to optimize the road network for better fuel efficiency.] In addition, the data may be used to determine when a certain vehicle has become less efficient and may require maintenance.

### BRIEF DESCRIPTION OF THE DRAWINGS

FIG. 1 is an illustration of a portable computing device;

FIG. 2 is an illustration of a steps of a method of estimating fuel consumption; and

FIG. 3 is an illustration of transportation segments.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

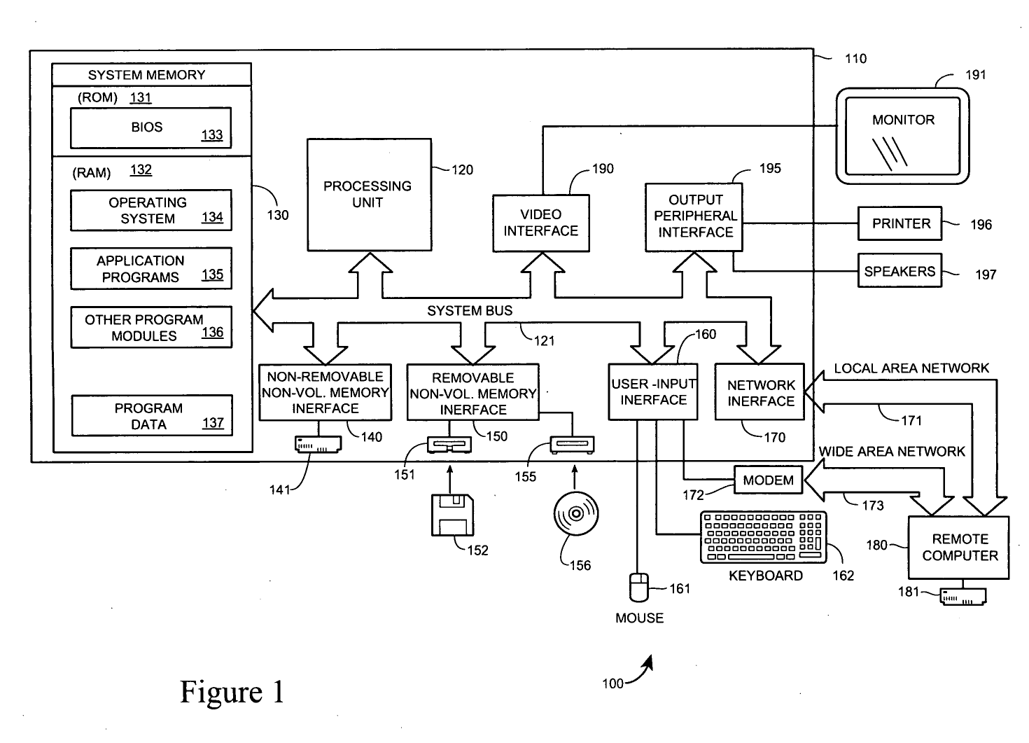

FIG. 1 illustrates an example of a suitable computing system environment 100 that may operate to execute the many embodiments of a method and system described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 20 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

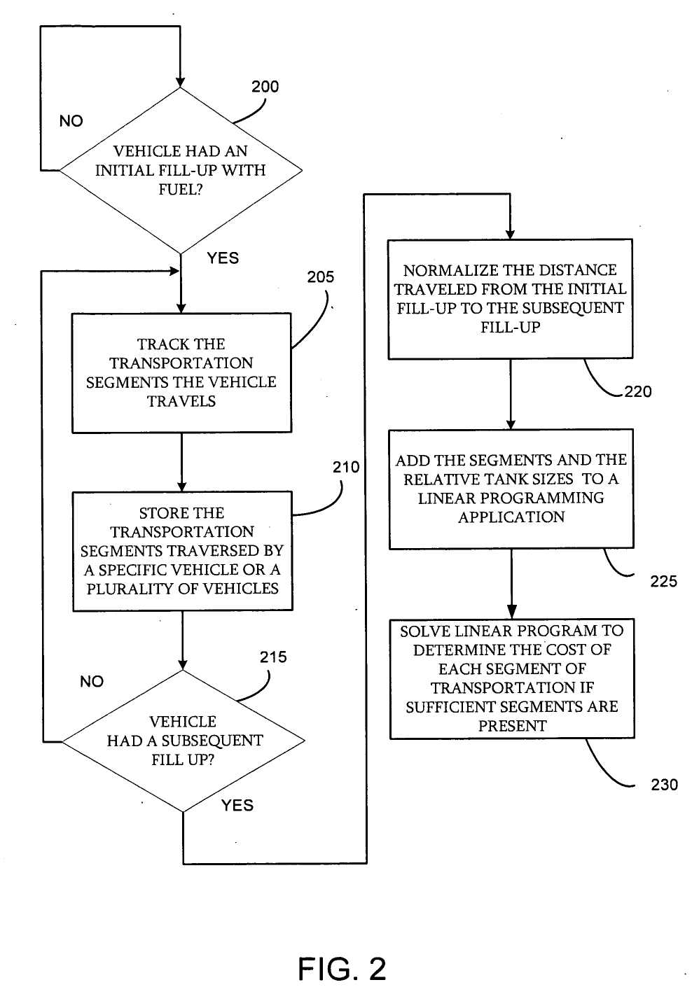

FIG. 2 illustrates a method of determining energy used on a transportation segment. The method, may have many embodiments and may be in many forms. It may be purely software or it may be purely hardware or a combination of hardware, such as a memory or processor, physically configured in accordance with software instructions. Of course, any and all possible embodiments are contemplated.

At block 200, it may be determined if a vehicle has had an initial fill-up with fuel. In one embodiment, the location of the vehicle is matched against a known location of filling stations. The vehicle may be any type of vehicle from a truck, to a train, to mass transportation, to airplanes and to a motorcycle. If the vehicle is stationary at a known filling station location for a sufficient period of time, it may be assumed that the vehicle was filled up with fuel. Fuel may be gasoline, diesel fuel, or any other power source delivered to the car, including electricity or other sources of energy.

In some embodiments, the vehicle will be assumed to be empty when it is refueled. In other embodiments, estimates may be made based on the miles traveled by the vehicle and historical fuel mileage. In yet another embodiment, the fuel station may be part of a network and data regarding the amount of fuel and the vehicle receiving the fuel may be obtained through the network. In another embodiment, the vehicle does not necessary need to be empty when refueling, but it may need to be at roughly the same percentage each time. For example, a certain person that fills the gas tank when it reaches ⅓ of its capacity, can also be used to estimate relative cost of road segment (although the gas consumption of his car may be estimated 50% higher than it should be.)]

The location of the vehicle may be determined in a variety of logical ways. In one embodiment, the location of a vehicle is determined by using GPS signals. Of course, permission from vehicle owners may be required before any locational methodology is used. In another embodiment, cell phone tower registration may be used. In yet another embodiment, toll charge registration data may be used to establish location. In another embodiment, a specific electronic device may be used to track vehicle location. In some embodiments, some of the methodologies may be combined to better establish location. Any electronic vehicle tracking system may be appropriate and may be used.

At block 205, the transportation segments the vehicle travels may be tracked. Again, the vehicle may be tracked using GPS, cell tower triangulation or any other appropriate methodology.

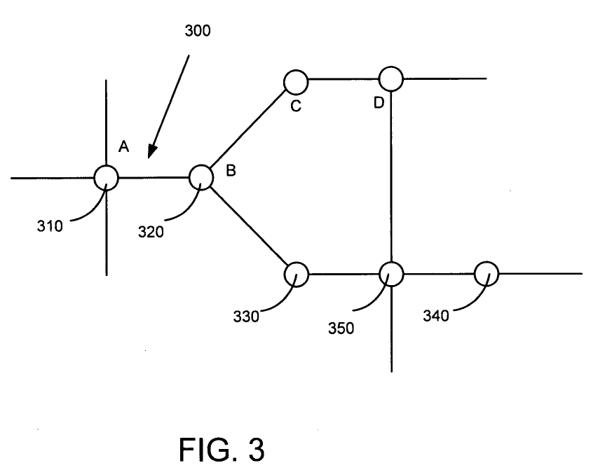

The transportation segments may be defined in a variety of ways. Referring to FIG. 3, in one embodiment, the transportation segment 300 is the roadway between two junction points, such as between a first set of cross streets 310 and a second set of cross streets 320. In another embodiment, the transportation segments 300 may be straight areas of roads such as from 330 to 340 which may include other intersections 350. In yet another embodiment, the transportation segments 300 may be longer stretches of roads that have been determined as being similar in some manner, such as having the same grade, have the same curvature, have the same number and type of stop lights, etc.

Referring again to FIG. 2, at block 210, the transportation segments 300 traversed by a specific vehicle or a plurality of vehicles may be stored in a storage device. The storage may be a network storage location or may be a remote storage location. In another embodiment, the transportation segments 300 traveled may be stored locally in the vehicle and may be communicated at various intervals. The various intervals may include when the vehicle is in range of an authorized wifi signal, when the vehicle is in for service, when the vehicle is stopped at a refilling station, etc.

At block 215, it may be determined if the vehicle has had a subsequent fill up with fuel. The determination of whether a subsequent fill-up has occurred may be similar to that of block 200 where a variety of methodologies may be used to determine that the vehicle has stopped at a filling station long enough to be refueled. In addition, logic may be used to assist in the determination that the vehicle has stopped for the subsequent fill-up such as when historical miles per gallon is used to calculate if a refuel is necessary. For example, an automobile may not stop to be refilled if has only travel 10 miles since the previous fill-up. If a subsequent fill-up has not been detected, control may pass to block 205.

If a subsequent fill-up has been detected, at block 220, the distance traveled from the initial fill-up to the subsequent fill-up with fuel may be normalized. The fuel tank size of cars may be different. Accordingly, some cars will be able to travel further on a tank of fuel. As a result, the size of the fuel tank may need to be normalized across different cars. One example the normalization may add all the transportation segments 300 together to equal a base tank size.

Transportation segment 1

sum length of r1 driven/number of times r1 driven*1/mpg=R1 Equation 1

Same thing for transportation segment 2

Sum length of r2 driven/number of time r2 drive*1/mpg=R2

r1+r2+ . . . +rk=1. Equation 2

This creates a linear formula, applying miles drive to miles per gallon to determine the gallons used on a transportation segment 300. Next, coefficients are determined to weight (or determine the cost) of the transportation segments 300 as fuel mileage is seldom linear. Driving up hills require more fuel than driving down hill. Stop-and-go driving takes more fuel than driving on a highway. Accordingly, some transportation segments 300 will be more costly than others.

Assume vehicle 1 normally travels 100 miles between fill-ups. Assume vehicle 2 travels 150 miles between fill-ups. The relative tank size would be 150/100.

Fb=150/100=1.5 Equation 3

For car b, 1.5 will be substituted for 1 in Equation 1

p1+p2+ . . . pk=1.5. Equation 4

At block 225, the transportation segments 300 and the relative tank sizes may be added to a linear programming application. Linear programming applications are tools that can easily solve equations with many variables so long as sufficient data is present. For example, a linear equation with five variables (transportation segments 300 in this case) will need five observed trips over the transportation segments 300 in question. Of course, additional observations will provide more reliable data. Over a period of time, the data will illustrate that certain transportation segments 300 are more costly than others.

At block 230, if sufficient transportation segments 300 are present, the linear program may be solved to determine the cost of each transportation segment 300. From above, each transportation segment 300 will be responsible for a certain part of the tank of fuel. The cost of the tank of fuel may be viewed as the cost. With enough observations, the cost of each transportation segment 300 may be determined.

In some embodiments, the miles per gallon (or other efficiency measure) may be used to determine if mileage has fallen by a significant amount. For example, if historical data for a vehicle indicates a car on known transportation segment 300 has an average cost of 10 and that cost increases to 15, then the method may inform the vehicle owner that it may be time for vehicle maintenance on the vehicle. Attempts may be made to observe if maintenance has occurred by determining if a vehicle stopped at a known maintenance location for a sufficient period of time. Again, this determination may be made by matching vehicle location to the location of known maintenance centers and determining if the vehicle has been at the maintenance location long enough for maintenance to have occurred.

The cost of transportation segments 300 may also be aggregated and used for a variety of purposes. In one example, the cost of transportation segments 300 may be used to determine the lowest cost path between two points. In another example, it may be determined which transportation segments 300 that have a highest cost and a lowest cost. In this way, further investigation may be undertaken to determine why certain transportation segments 300 are so costly, such as, the road needs to be widened or that the traffic signals on the transportation segment 300 need to be adjusted. In the same vein, roads that are relatively cheap may be reviewed to determine if lessons may be learned on how to design more efficient traffic patterns.

In a further extension, the determined transportation segment 300 cost may be used determine a toll for each road transportation segment 300. For example, if a transportation segment 300 has a high cost due to being overused, a high toll may be used to encourage people to use another transportation segment 300. At the same time, transportation segments 300 that have a low cost may have lower tolls to attract more users and more efficient travel. Congestion management pricing may be based on the costs associated with each transportation segment 300.

Related, costs may be determine for each transportation segment 300 at different times or time intervals. For example, a cost of a transportation segment 300 at 3 am is likely to be low as low traffic will allow traffic to freely and efficiently flow. At the same time, a cost of a transportation segment 300 at 5 pm is likely to be higher as high traffic will cause traffic to move slowly and inefficiently. Using this time cost data, the cost of traveling between two locations at a given time interval of time may be determined. For example, routes that are longer but not busy at rush hour may be end up being less costly than a route that is shorter but subject to more congestion. Similarly, the cost to travel transportation segments 300 during different seasons may be created. For example, some transportation segments 300 may be difficult to efficiently travel in the winter as the roads may be steep and winding and ice and snow may cause the travel to be especially slow. Similarly, transportation segments 300 leading to and from summer resorts may become jammed during the summer.

Reports may be created that list the cost of transportation segments 300 during various time and tolls may also be set according to the time of day cost of transportation segments 300 to encourage drivers to use less costly roads. Using the cost of various transportation segments 300 at different times of the day, more precise lowest cost route guidance and reports may be provided based on the time of day of the proposed trip.

The method may be applied to virtually any mode of transportation. For example, aerial routes may be subject to trade winds that vary with time, season, etc. In another example, naval travel also make use of the embodiments of the method as ocean currents and trade winds may affect travel. The logical extensions of the method are many and are contemplated.

In conclusion, the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

1. A method of determining energy used on a transportation segment comprising:
determining if a vehicle has had an initial fill-up with a fuel;
tracking the transportation segment the vehicle travels;
storing the transportation segment in a storage device;
determining if the vehicle has had a subsequent fill up with the fuel;
normalizing distance traveled from the initial fill-up to the subsequent fill-up with the fuel;
adding the transportation segment to a linear programming application; and
if sufficient transportation segments are present; solving the linear programming application to determine a cost of the transportation segment.

2. The method of claim 1, wherein determining if the initial fill-up or the subsequent fill-up has occurred further comprises determining if the vehicle has stopped at a known filling station for a sufficient time to fill the vehicle.

3. The method of claim 1, wherein energy comprises the fuel used.

4. The method of claim 1, wherein location of the vehicle is determined using at least one selected from a group comprising:
GPS data from a GPS device in the vehicle;
cellular tower registration data; and
toll charge registration data.

5. The method of claim 1, further comprising storing fuel mileage for a specific vehicle.

6. The method of claim 5, further comprising comparing a fuel mileage for a specific vehicle and determining if mileage has fallen by a significant amount.

7. The method of claim 6, further comprising if the fuel mileage has fallen by a significant amount, advise a vehicle possessor to consider vehicle maintenance.

8. The method of claim 7, further comprising determining if maintenance has occurred by determining if the vehicle stopped at a known maintenance location for a sufficient period of time.

9. The method of claim 1, further comprising using cost of a plurality of the transportation segment to determine a lowest cost path between two points.

10. The method of claim 9, further comprising determining transportation segments that have a highest cost and a lowest cost.

11. The method of claim 1, further comprising using the cost of each of the transportation segments to determine a toll for each of the transportation segment.

12. The method of claim 1, further comprising determining the cost for the transportation segment for a specific time or time interval wherein the cost for the transportation segment for the specific time comprises a transportation segment cost calculated at different time of a day.

13. The method of claim 12, further comprising determining lowest costs at specific times comprising using the cost for the transportation segment for the specific time.

14. The method of claim 12, further comprising determining a road toll based on the cost for the transportation segment for the specific time.

15. The method of claim 12, further comprising providing at least one report selected from a group comprising:
a report of the transportation segment cost at a plurality of specific times or time intervals;
a report of a lowest costs times or time intervals to use the transportation segment; and
a report of a lowest cost time or time intervals to travel from a first location to a second location.

16. A computing system comprising a processor physically configured in accordance with computer executable instructions for determining energy used on a transportation segment, a memory physically confirmed to store computer executable instructions and an input/output circuit, the computer executable instructions comprising instructions for:
determining if a vehicle has had an initial fill-up with a fuel;
tracking the transportation segment the vehicle travels;
storing the transportation segment in a storage device;
determining if the vehicle has had a subsequent fill up with the fuel further comprises determining if the vehicle has stopped at a known filling station for a sufficient time to fill the vehicle;
normalizing distance traveled from the initial fill-up to the subsequent fill-up with the fuel;
adding the transportation segment to a linear programming application; and
if sufficient transportation segments are present; solving the linear programming application to determine a cost of the transportation segment.

17. The computer system of claim 16, wherein location of the vehicle is determined using at least one selected from a group comprising:
GPS data from a GPS device in the vehicle;
cellular tower registration data; and
toll charge registration data.

18. The computer system of claim 16, further comprising:
storing fuel mileage for a specific vehicle;
comparing a fuel mileage for a specific vehicle and determining if mileage has fallen by a significant amount; and
if the fuel mileage has fallen by a significant amount, advise a vehicle possessor to consider vehicle maintenance.

19. The computer system of claim 16, further comprising using cost of a plurality of the transportation segment to determining transportation segments that have a highest cost and a lowest cost and using the cost of each of the transportation segments to determine a toll for each of the transportation segment.

20. The computer system of claim 16, further comprising providing at least one report selected from a group comprising:
a report of the transportation segment cost at a plurality of specific times or time intervals;
a report of a lowest costs times or time intervals to use the transportation segment; and
a report of a lowest cost time or time intervals to travel from a first location to a second location.
